(19) United States
(12) Patent Application Publication
(10) Pub. No.: US 2018/0112794 A1
(43) Pub. Date: Apr. 26, 2018

(54) SAFETY VALVE

(71) Applicants: Paul Michael Challen, Airdrie (CA); Herbert Darius Stahl, Chestermere (CA)

(72) Inventors: Paul Michael Challen, Airdrie (CA); Herbert Darius Stahl, Chestermere (CA)

(21) Appl. No.: 15/331,577

(22) Filed: Oct. 21, 2016

(51) Int. Cl. F16K 31/42; F16K 17/38; F16K 1/12; F16K 21/04

(52) U.S. Cl. CPC F16K 31/423; F16K 21/04; F16K 1/126; F16K 17/383

(57) ABSTRACT

A gas valve comprises a valve body having a flow passage therethrough between inlet port and outlet ports, a piston slidably located within the flow passage movable between a closed and an open position and a cavity defined by an opening in the valve body and a slidably movable surface, the slidably movable surface being operably connected to the piston. The gas valve further comprises a pre-charge passage extending from the flow passage to the inlet port to the cavity, a pilot line extending from the flow passage proximate to the outlet port to the cavity, a pilot valve located within the pilot line to control flow of gas through the pilot line and a solenoid operable to open or close the pilot valve. A method of opening a gas valve comprises actuating the solenoid to open the pilot valve, depressurizing the cavity so as to move the slidably movable surface and slidably displacing the piston to the open position.

### BACKGROUND OF THE INVENTION

### 1. Field of Invention

The present invention relates generally to valves and in particular to a safety shut off valve for use in gas fueled devices.

### 2. Description of Related Art

Gaseous fuels are a common source of heat and energy for a variety of purposes such as cooking heating or the like. Commonly the flow of gas to the device which utilizes the gas is controlled through the use of a valve. Commonly such valves may be activated to open or restrict the flow of gas therethrough.

Several disadvantages with conventional gas valves currently exist. In particular, as conventional valves are opened or closed according to the wishes of a user, such valves may be prone to being left in the open position in which position some gas may continue to leak through the appliance utilizing such gas after user has stopped using the appliance. Additionally, in many situations, it is desirable to turn off the flow of gas through the valve, such as in the case of a fire or overheating condition in and around the appliance. Conventional valves have not adequately addressed these needs.

### SUMMARY OF THE INVENTION

According to a first embodiment of the present invention there is disclosed a gas valve comprising a valve body having a flow passage therethrough between inlet port and outlet ports, a piston slidably located within the flow passage movable between a closed position adapted to block the flow passage and an open position adapted to permit flow through the flow passage and a cavity defined by an opening in the valve body and a slidably movable surface, the slidably movable surface being operably connected to the piston. The gas valve further comprises a pre-charge passage extending from the flow passage to the inlet port to the cavity, a pilot line extending from the flow passage proximate to the outlet port to the cavity, a pilot valve located within the pilot line to control flow of gas through the pilot line and a solenoid operable to open or close the pilot valve.

The outlet port and the inlet port may extend along a common axis through the valve body. The piston may be slidably movable along a path perpendicular to the common axis. The piston may extend between front and rear surfaces. The slidably movable surface may comprise the rear surface of the piston.

The cavity may contain the piston therein. The cavity may include an annular wall extending thereinto from the valve body proximate to the flow passage adapted to be sealably engaged with the piston in the closed position. The valve body may include a barrier wall extending thereacross having a free distal edge adapted to be sealably engaged with the front face of the piston in the closed position.

The solenoid may be electric. The piston may be biased to the closed position with a spring. The spring may be located within the cavity. The gas valve may further comprise a temperature sensor adapted to disengage the solenoid to close the pilot valve when a temperature above a predetermined threshold is measured. The gas valve may further comprise a timer adapted to disengage the solenoid to close the pilot valve after a predetermined time has elapsed.

According to a further embodiment of the present invention there is disclosed a method of restricting gas flow comprising providing a valve body having a flow passage therethrough between inlet port and outlet ports and slidably locating a piston within the flow passage movable between a closed position adapted to block the flow passage and an open position adapted to permit flow through the flow passage and providing a cavity defined by an opening in the valve body and a slidably movable surface, the slidably movable surface being operably connected to the piston. The method further comprises providing a pre-charge passage extending from the flow passage to the inlet port to the cavity and a pilot line extending from the flow passage proximate to the outlet port to the cavity, providing a pilot valve located within the pilot line to control flow of gas through the pilot line and providing a solenoid operable to open or close the pilot valve.

According to a further embodiment of the present invention there is disclosed a method of opening a gas valve comprising providing a valve body having a flow passage therethrough between inlet port and outlet ports and actuating a solenoid connected to a pilot valve located within a pilot line extending from the flow passage proximate to the outlet port to a cavity defined by an opening in the valve body and a slidably movable surface. The method further comprises pressurizing a cavity through a pre-charge passage extending from the flow passage to the inlet port to the cavity, releasing a pressure within the cavity through the pilot line so as to move the slidably movable surface as the cavity expands in volume and slidably displacing a piston operably connected to the slidably movable surface within a flow passage of the valve body from a closed position adapted to block the flow passage to an open position adapted to permit flow through the flow passage.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a gas flow valve according to a first embodiment of the present invention.

FIG. 2 is a cross sectional view of the valve of FIG. 1 at a first or closed position.

FIG. 3 is a cross sectional vie of the valve of FIG. 2 at a second or open position.

### DETAILED DESCRIPTION

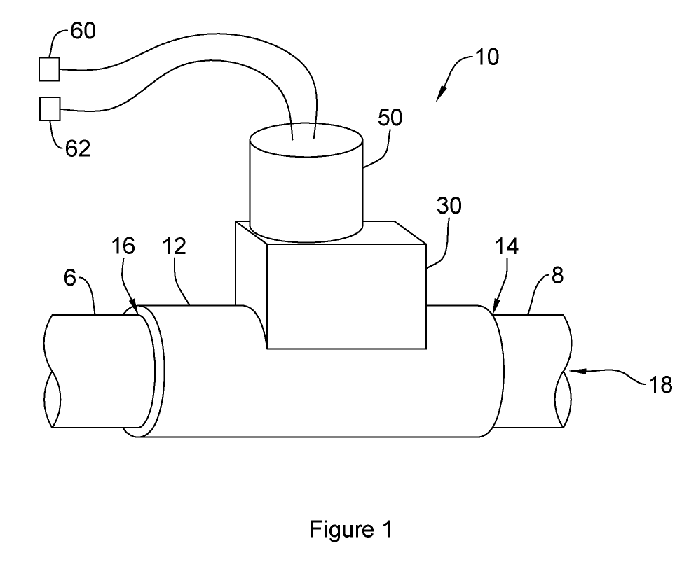

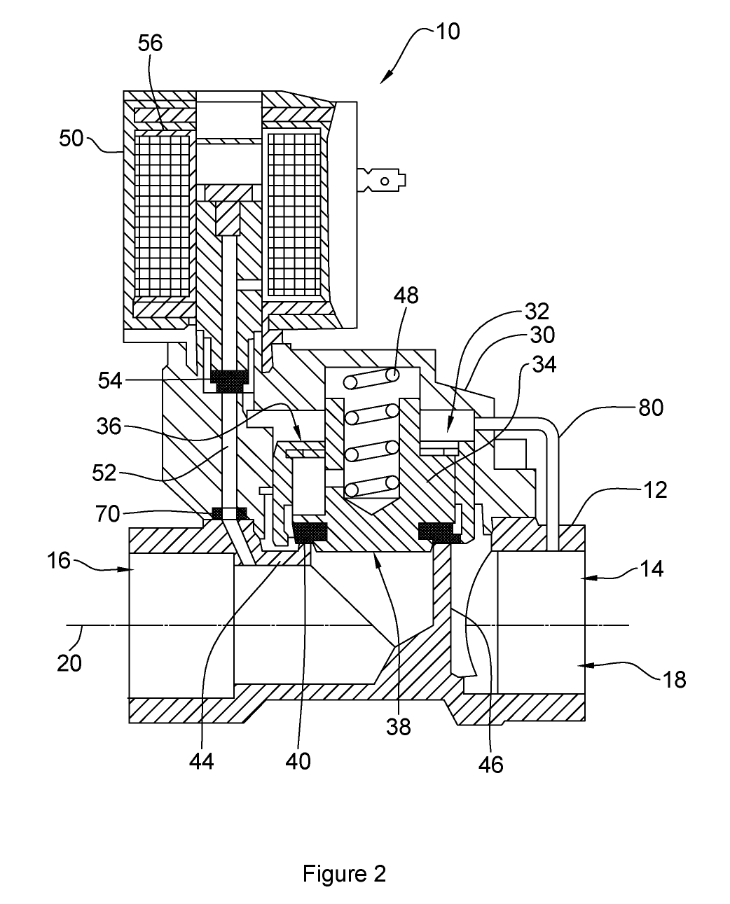

Referring to FIG. 1, a valve for controlling the flow of gas to an appliance (not shown) according to a first embodiment of the invention is shown generally at 10. As illustrated in FIG. 1, the valve 10 is adapted to be located inline within a gas pipe between an inlet pipe 8 originating at a gas source (not shown) and an outlet pipe 6 extending to the appliance both of which are commonly known. The valve 10 includes a valve body 12 having inlet and outlet ports, 14 and 16, respectively as are commonly known. The valve body 12 forms a passage 18 extending from the inlet port 14 to the outlet port 16 as will be more fully described below. As illustrated in FIG. 2, the inlet and outlet ports 14 and 16 may extend along a common axis 20 although other orientations may be useful as well.

The valve body 12 includes a housing extension 30 extending from one side thereof with a solenoid housing 50 extending from the housing extension. The housing extension includes a piston or other means for closing the valve therein while the solenoid housing includes a solenoid valve for actuating the piston to open and close the valve 10 as will be more fully described below. As illustrated in FIG. 1, the valve 10 may include a temperature sensor 60 operable to sense the temperature of the valve body 12 or other component and a timer 62 operable to measure a predetermined time the operation of both of which will be more fully described below.

With reference to FIG. 2, a cross sectional view of the valve 10 is illustrated. As illustrated in FIG. 2, the housing extension 30 defines a cavity 32 having a slidable piston 34 located therein. The piston 34 extends between front and rear surface 38 and 36, respectively wherein the rear surface 36 defines a movable wall to the cavity 32.

As illustrated in FIG. 2, the valve body 12 includes an annular wall 44 extending therefrom into the cavity 32 below the bottom of the piston. The valve body also includes a dividing wall 46 extending into the passage and terminating at a position corresponding to the annular wall 44 to engage upon the front surface 38 of the piston at the bottom or closed position as illustrated in FIG. 2. The front surface 38 includes seal 40 located therearound at a position adapted to engage upon and seal on the annular wall 44 and dividing wall 46 so as to seal the inlet and outlet ports from each other at the bottom or closed position of the piston 34. Optionally, the cavity 32 may include a spring 48 or other biasing means therein adapted to bias the piston 34 to the closed position illustrated in FIG. 2.

As illustrated in FIG. 2, the valve body includes a pre-charge line 80 extending from the passage 18 upstream of the barrier wall 46 to cavity 32. The pre-charge line 80 permits a predetermined rate of fluid to enter the cavity 32 to provide an initial closing force above the piston 34. The valve body 12 also includes a pilot line 52 extending from the passage 18 downstream of the barrier wall 46 such as at a position proximate to the outlet port 16 by way of non-limiting example. The pilot line 52 extends to the cavity 32 as set out above and includes a pilot valve 54 therein, such as a needle valve, by way of non-limiting example. The pilot valve 54 is operated by an actuator, such as a solenoid 56, by way of non-limiting example. The solenoid 56 may be electric although other solenoid types, such as pneumatic or hydraulic may also be utilized.

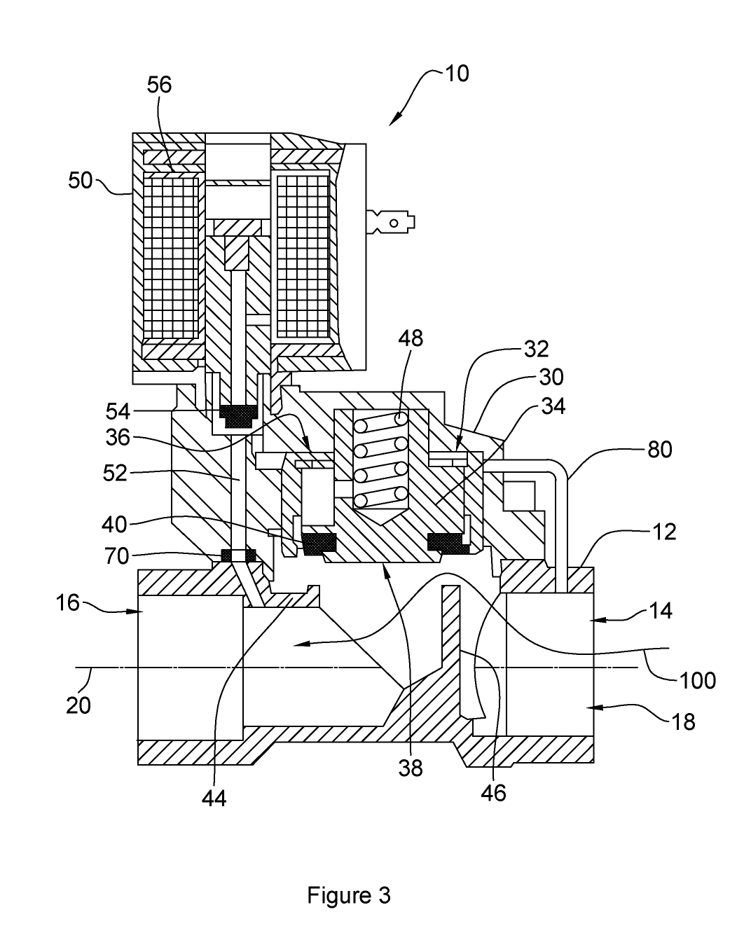

As illustrated in FIG. 2, the piston 34 may be located at a first or closed position with the seal 40 resting against the annular wall 44 and barrier wall 46. The piston may also be retracted to a second or open position with the seal 40 disengaged from the annular wall 44 and barrier wall 46 as illustrated in FIG. 3.

In operation, the piston 34 will be biased to the closed position as illustrated in FIG. 2 by the spring 48. When the valve is connected to an inlet pipe 8 having a pressurized gas flowing thereinto, the gas flow through the pre-charge passage 80 into the cavity thereby providing an additional closing force on the piston 34 and will also act upon the front surface 38 upstream of the barrier wall 46. The portion of the front surface 38 upstream of the barrier wall however will be selected such that this pressure will be insufficient to lift the piston 34 against the gas in the cavity 32. When the valve is desired to be opened, the solenoid 56 opens the pilot valve 54 so as to release the gas contained within the cavity 32 at which time the gas acting upon the front surface 38 upstream of the barrier wall 46 will be sufficient to lift the piston 34 away from the barrier wall 46 and the annular wall 44 at an open position as illustrated in FIG. 3 thereby permitting gas to flow through the gas passage 18 in a direction generally indicated at 100 in FIG. 3.

When the valve is desired to be shut off, the solenoid 56 closes the pilot valve 54 thereby permitting gas to accumulate within the cavity 32 through the pre-charge passage 80 such that the pressure above the piston 30 is greater than below thereby pressing the piston 34 to the closed position.

As illustrated in FIG. 1, the valve may include a temperature sensor and a timer 60 and 62 operable to cause the solenoid 56 to close the pilot valve 54 so as to cause the piston to be moved to the closed position illustrated in FIG. 3. The temperature sensor and timer 60 and 62 may be included within the valve body to or may optionally be located remotely from the valve. It will be appreciated that the temperature sensor and timer provide an additional protection against prolonged leaking of gas through the valve and excessive heating, both of which may lead to an unsafe condition. By way of non-limiting example, the timer 60 may be activated when the valve solenoid valve is opened and may be adapted to automatically close the solenoid and therefore the valve after a predetermined time after which it must be opened by a user again. Optionally, the pilot line 52 may include a disk 70 formed of a meltable material such that it may be melted by a temperature above a pre-determined level so as to seal off the pilot line 52 upon the valve experiencing an elevated temperature thereby closing the valve.

Optionally, the valve 10 may be adapted for use in water, such as, by way of non-limiting example, in a septic tank or the like by forming the body of the valve of a plastic or other non-corroding material. Additionally, the pilot line 80 may be omitted in such embodiments.

While specific embodiments of the invention have been described and illustrated, such embodiments should be considered illustrative of the invention only and not as limiting the invention as construed in accordance with the accompanying claims.

What is claimed is:

1. A gas valve comprising:
a valve body having a flow passage therethrough between inlet port and outlet ports;
a piston slidably located within said flow passage movable between a closed position adapted to block said flow passage and an open position adapted to permit flow through said flow passage;
a cavity defined by an opening in said valve body and a slidably movable surface, said slidably movable surface being operably connected to said piston;
a pre-charge passage extending from said flow passage to said inlet port to said cavity;
a pilot line extending from said flow passage proximate to said outlet port to said cavity;
a pilot valve located within said pilot line to control flow of gas through said pilot line; and
a solenoid operable to open or close said pilot valve.

2. The gas valve of claim 1 wherein said outlet port and said inlet port extend along a common axis through said valve body.

3. The gas valve of claim 1 wherein said piston is slidably movable along a path perpendicular to said common axis.

4. The gas valve of claim 3 wherein said piston extends between front and rear surfaces.

5. The gas valve of claim 4 wherein said slidably movable surface comprises said rear surface of said piston.

6. The gas valve of claim 5 wherein said cavity contains said piston therein.

7. The gas valve of claim 6 wherein said cavity includes an annular wall extending thereinto from said valve body proximate to said flow passage adapted to be sealably engaged with said piston in said closed position.

8. The gas valve of claim 6 wherein said valve body includes a barrier wall extending thereacross having a free distal edge adapted to be sealably engaged with said front face of said piston in said closed position.

9. The gas valve of claim 1 wherein said solenoid is electric.

10. The gas valve of claim 1 wherein said piston is biased to said closed position with a spring.

11. The gas valve of claim 1 wherein said spring is located within said cavity.

12. The gas valve of claim 1 further comprising a temperature sensor adapted to disengage said solenoid to close said pilot valve when a temperature above a predetermined threshold is measured.

13. The gas valve of claim 1 further comprising a timer adapted to disengage said solenoid to close said pilot valve after a predetermined time has elapsed.

14. A method of restricting gas flow comprising:
providing a valve body having a flow passage therethrough between inlet port and outlet ports;
slidably locating a piston within said flow passage movable between a closed position adapted to block said flow passage and an open position adapted to permit flow through said flow passage;
providing a cavity defined by an opening in said valve body and a slidably movable surface, said slidably movable surface being operably connected to said piston;
providing a pre-charge passage extending from said flow passage to said inlet port to said cavity;
providing a pilot line extending from said flow passage proximate to said outlet port to said cavity;
providing a pilot valve located within said pilot line to control flow of gas through said pilot line; and
providing a solenoid operable to open or close said pilot valve.

15. A method of opening a gas valve comprising:
providing a valve body having a flow passage therethrough between inlet port and outlet ports;
actuating a solenoid connected to a pilot valve located within a pilot line extending from said flow passage proximate to said outlet port to a cavity defined by an opening in said valve body and a slidably movable surface;
pressurizing a cavity through a pre-charge passage extending from said flow passage to said inlet port to said cavity;
releasing a pressure within said cavity through said pilot line so as to move said slidably movable surface as said cavity expands in volume; and
slidably displacing a piston operably connected to said slidably movable surface within a flow passage of said valve body from a closed position adapted to block said flow passage to an open position adapted to permit flow through said flow passage.
